(19) United States
(12) Patent Application Publication
(10) Pub. No.: US 2022/0285899 A1
(43) Pub. Date: Sep. 8, 2022

(54) RECEPTACLE BOX WITH MOLDED PLUGIN CONNECTION

(71) Applicant: Gregory Clarence Ettel, Glencoe, MN (US)

(72) Inventor: Gregory Clarence Ettel, Glencoe, MN (US)

(21) Appl. No.: 17/589,057

(22) Filed: Jan. 31, 2022

Related U.S. Application Data
(60) Provisional application No. 63/155,475, filed on Mar. 2, 2021.

(51) Int. Cl. H01R 33/76; H01R 13/516; H01R 31/06; H02G 3/14; H01R 9/24

(52) U.S. Cl. CPC H01R 33/76; H01R 13/516; H01R 33/7671; H01R 31/06; H02G 3/14; H01R 9/2491; H01R 33/97

(57) ABSTRACT

An electrical receptacle box defines a receiving chamber that has a first set of push-in receiver connectors for receiving elongate prongs on an electrical device that is inserted into the receiving chamber. The first and second sets of push-in receiver connectors are electrically connected to one another so that the elongate prongs on the electrical device inserted into the first set of push-in receiving connectors receive power from the power wires inserted into the second set of push-in receiver connectors. The receiving chamber can have a wall that forms a periphery defining an opening to the receiving chamber. The electrical device can be integrally formed with (or otherwise fixedly attached to) a faceplate that can be fitted to, and attached to, the wall defining the periphery of the opening in the receiving chamber.

### CROSS-REFERENCE TO RELATED APPLICATION

The present application is based on and claims the benefit of U.S. provisional patent application Ser. No. 63/155,475, filed Mar. 2, 2021, the content of which is hereby incorporated by reference in its entirety.

### FIELD OF THE DESCRIPTION

The present description is related to electrical connection mechanisms. More specifically, the present description is related to a receptacle box with a plugin connector.

### BACKGROUND

Receptacle boxes are currently used in electrical wiring for residential and commercial applications. Receptacle boxes often have a fastening mechanism by which they can be fastened to a wall stud, and the boxes have an enclosure that defines a receiving chamber.

Different electrical devices can be received within the receiving chamber, such as one or more outlets, one or more switches, ground fault outlets, among others. In order to electrically connect the electrical devices, power is brought to the receptacle box through a set of power wires. The electrical device often has its own set of wires that are then connected to the power wires. In some examples, the ends of the power wires are stripped of an insulator, and the electrical device wires are also stripped of their insulators, and the sets of wires are connected together using wiring nuts.

In other examples, the power wires are connected to the receptacle box using terminals that secure the power wires using screws. Even in these examples, the electrical device (such as the outlet, the switch, etc.) still has a set of wires that needs to be stripped and connected to the terminals inside the receptacle box.

These types of wiring systems are cumbersome. They also make it difficult to change the electrical device. For instance, if a resident wishes to switch the electrical device from an on/off type switch to a dimmer switch, the resident will be exposed to the bare conductors of the power wires, or the bare wires of the electrical devices that are being replaced.

### SUMMARY

An electrical receptacle box defines a receiving chamber that has a first set of push-in receiver connectors for receiving elongate prongs on an electrical device that is inserted into the receiving chamber, and a second set of push-in receiver connectors for receiving power wires. The first and second sets of push-in receiver connectors are electrically connected to one another so that the elongate prongs on the electrical device inserted into the first set of push-in receiver connectors receive power from the power wires inserted into the second set of push-in receiver connectors. The receiving chamber can have a wall that forms a periphery defining an opening to the receiving chamber. The electrical device can be integrally formed with (or otherwise fixedly attached to) a faceplate that can be fitted to, and attached to, the wall defining the periphery of the opening in the receiving chamber.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is an exploded view of one example of an electrical receptacle.

FIG. 2 is a front view of one example of an electrical receptacle.

FIG. 3 is a top view of one example of an electrical receptacle.

FIG. 4 is a top view of one example of an electrical receptacle showing a first set of power wires connected to a set of input connectors and a second set of power wires connected to a set of output connectors.

FIG. 5 shows one example of how two sets of connectors can be electrically connected to one another.

FIG. 6 shows a second example of how two sets of connectors can be electrically connected to one another.

FIG. 7 shows one example of a connection mechanism that can be used as a push-in type electrical connector.

FIGS. 8 and 9 are two perspective views of one example of a face plate with integrally formed outlets that are electrically connected to elongate members or studs.

FIG. 10 is a perspective view of another example of a face plate with an integrally formed switch that is electrically connected to a set of elongate members or studs.

### DETAILED DESCRIPTION

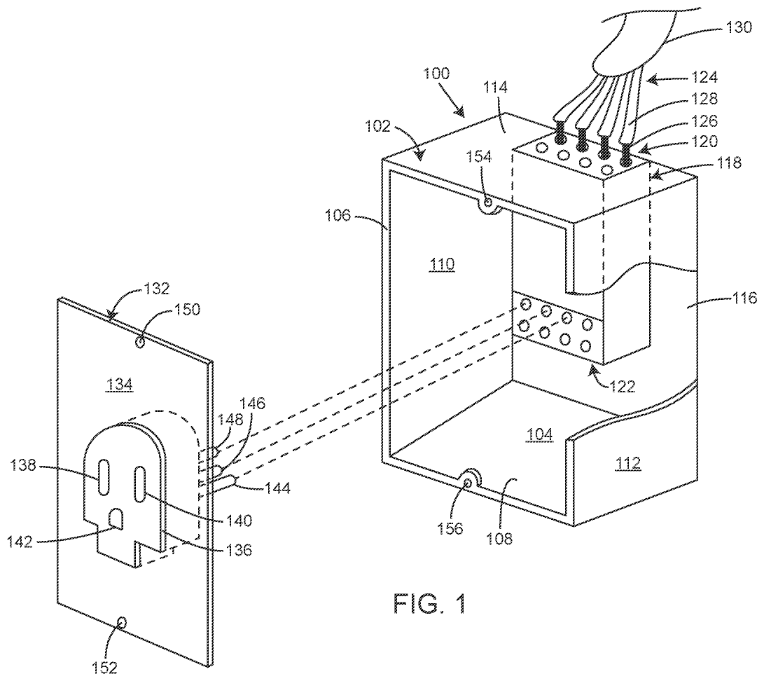

FIG. 1 is an exploded view of one example of an electrical receptacle 100 that is configured as an enclosure 102 that defines a receiving chamber 104. The enclosure 102 is illustratively formed of non-conductive material and includes an edge 106 that defines a periphery of an opening to receiving chamber 104. The enclosure 102 thus includes a floor 108, two opposing sides walls 110 and 112, an upper wall 114 and a back wall 116. A portion of side wall 112 is cut away in FIG. 1 for the sake of illustration.

In the example shown in FIG. 1, the back wall 116 has an integrally formed junction box 118. Junction box 118 can be molded into (or otherwise fixedly attached to—such as with adhesive) one or more of the floor 108 or walls 110, 112, 114 and/or 116. Junction box 118 has a first set of push-in type receiving connectors 120 and a second set of push-in type receiving connectors 122. Connectors 120 and 122 are configured to receive conductors that are inserted within the connectors and frictionally engage and retain the conductors therein. The push-in type receiving connectors 120 are electrically connected to the push-in type receiving connectors 122. The electrical connection between connectors 120 and 122 can take a variety of different forms, some of which are described below.

FIG. 1 shows that a set of power wires 124 have distal ends that have been stripped and inserted into one set of the push-in type connectors 120. Each of the wires 124 illustratively has a conductor portion 126 that is surrounded by an insulator portion 128. The group of wires 124 can also be surrounded by an additional insulator 130. The conductors 126 can be single conductors or multi-strand conductors which may be braided or arranged in other arrangements.

FIG. 1 also shows an example in which a faceplate assembly 132 has a faceplate 134 with an integrally formed outlet 136 that has a plurality of apertures 138, 140, and 142 defined therein. Apertures 138, 140 and 142 each have conductors that are electrically connected to a set of elongate members or studs 144, 146 and 148 that extend in a direction away from apertures 138, 140, and 142. The elongate members or studs 144, 146, and 148 are sized and positioned to fit into a set of the push-in type receiving connectors 122. Therefore, depending upon configuration of studs 144, 146, and 148, and depending upon the configuration of the electrical connection between connectors 120 and 122, the different studs 144, 146, and 148 will be connected to the different power wires 124 when studs 144, 146, and 148 are pushed into, and received by, the set of connectors 122.

In the example shown in FIG. 1, the exterior periphery of faceplate 134 is sized to cover or abut against the periphery defined by edge 106 of receptacle box 100. When faceplate 134 is in abutment with edge 106, studs 144, 146, and 148 are sized such that they are adequately received within the push-in connectors 122 to make electrical contact therewith. Similarly, the studs 144, 146, and 148 are sized and positioned such that, when they are inserted into connectors 122, the studs are frictionally held within connectors 122. Also, a set of fastener receiving apertures 150 and 152 on faceplate 134 are in alignment with mounting apertures 154 and 156 on receptacle 100. Therefore, screws or other fastening devices can be used to fasten faceplate 134 to receptacle 100.

It can thus be seen that power is provided from wires 124 to electrical device 136 without using any wiring nuts or screw terminals, and without ever exposing the user to bare electrical wires or connectors within receptacle 100. The connection of power wires 124 to connectors 120 is efficient, and the connection of electrical device 136 to connectors 122 can be done quickly and efficiently without exposure to bare wires or bare connectors.

Therefore, if the user wishes to change the electrical device 136 to a different electrical device (such as to a two-outlet configuration), then the user simply needs to remove faceplate 134 and the integrally molded (or otherwise integrally formed or fixedly attached) electrical device 136 and replace it with another faceplate that has one or more other electrical devices that are integrally formed or fixedly attached to that faceplate. The configuration of the electrical connections in connector box 118 is illustratively standardized so that faceplates 134 with integrally formed or fixedly attached electrical devices 136 can be manufactured with desired stud configurations so that, when plugged into a connector box 118, power is properly supplied to the electrical device connected to the faceplate.

It will also be noted that, while not shown in FIG. 1, receptacle 100 will illustratively be provided with some means of connecting it to a wall stud, or another support structure. For instance, one or more of the walls 110 and 112 may have pre-formed holes for receiving fasteners so that receptacle 100 can be screwed into a wooden wall stud, or attached to a metal wall stud, through the hole. One or more tabs may be provided that extend from the periphery 106 or another exterior surface of receptacle 100, and those tabs may be connectable to a wall stud or to another support structure. These and other connection mechanisms can be used to connect receptacle 100 to a support structure.

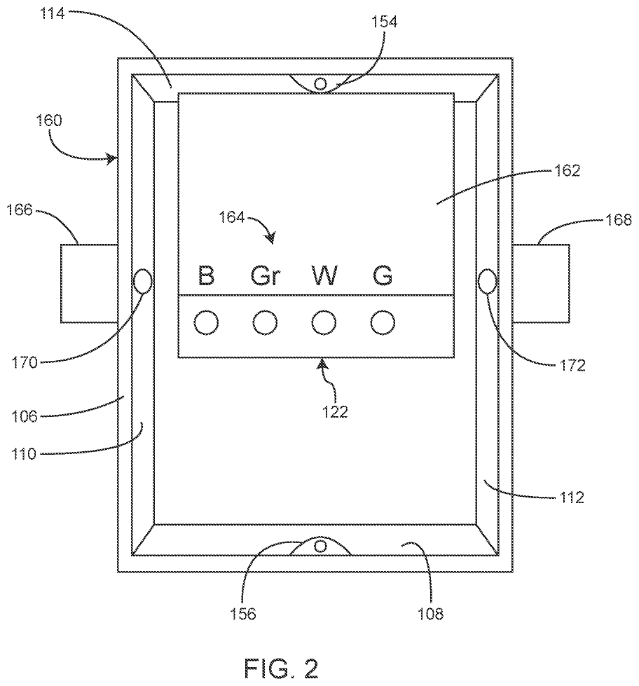

FIG. 2 is a front view of another example of a receptacle 160. Some items of receptacle 160 are similar to those shown on receptacle 100 in FIG. 1 and they are similarly numbered. FIG. 2 shows that receptacle 160 has a different connector box 162 in which only a single row of push-in type receiving connectors 122 is provided for receiving the extending members or studs extending from an electrical device that may be connected to a faceplate. Also, in the example shown in FIG. 2, the single row of push-in type connectors 122 are labeled with alphanumeric or other characters or symbols shown generally at 164. The alphanumeric or other characters or symbols 164 identify which power wires will be connected to the extending members or studs inserted within the corresponding plug-in type receiving connectors 122. Further, receptacle 160 has a plurality of break-away tabs 166 and 168. The break-away tabs can be used for aligning receptacle 160 with drywall or another wall surface. A set of fastening holes 170 and 172 can be formed in the side walls 110 and 112 (or elsewhere) and used for fastening receptacle 160 to a support structure, such as a wooden wall stud, a metal wall stud, etc.

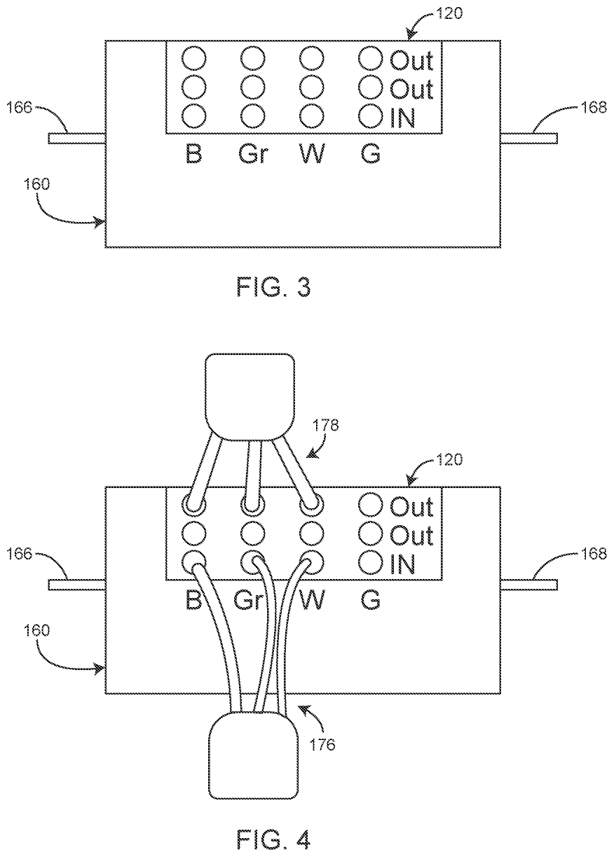

FIG. 3 is a top view of one example of the receptacle 160, shown in FIG. 2. Some items are similar to those shown in FIG. 2, and they are similarly numbered in FIG. 3. FIG. 3 shows that, instead of having two rows of push-in type receiving connectors 120 (as shown in FIG. 1) the receptacle 160 shown in FIG. 3 has three rows of push-in type receiving connectors 120. One row is labeled “IN” and is designated for receiving power input from the set of power wires 124. Two rows of connectors 120 are labeled “OUT” and can be used to route power downstream of receptacle 160 in an electrical circuit.

FIG. 4 is another top view of receptacle 160, similar to that shown in FIG. 3, and similar items are similarly numbered. FIG. 4 shows that a set of power wires 176 is connected to the row of input connectors, and another set of power wires 178 is connected to an output row of connectors so that power can be supplied to other devices, downstream of receptacle 160.

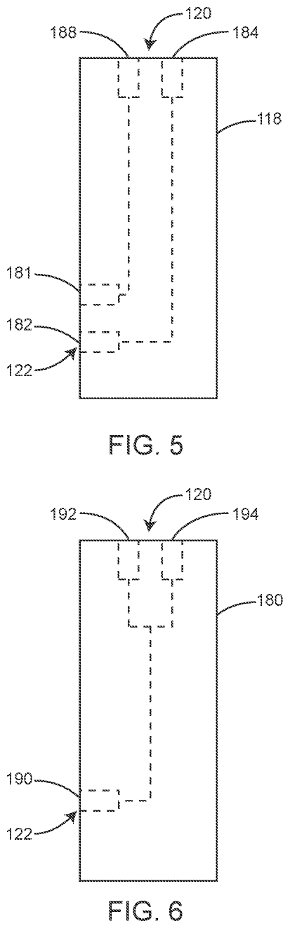

FIGS. 5 and 6 show partial schematic views of two different electrical connector boxes 118 and 180. Electrical connector box 118 is similar to that shown in FIG. 1. FIG. 5 shows that a first row 182 of electrical connectors 122 is electrically connected to a first row 184 of electrical connectors 120. Similarly, FIG. 5 shows that a second row 186 of electrical connectors 122 is electrically connected to a second row 188 of connectors 120. This is simply one way of how the different rows of connectors 122 and 120 can be electrically connected to one another.

FIG. 6 shows a second example in which a single row 190 of connectors 122 is connected to two different rows 192 and 194 of connectors 120. Of course, it will be appreciated that the different individual connectors in row 190 may be connected to different individual connectors in rows 192 and 194. It will also be appreciated that the electrical connections shown in FIGS. 5 and 6 are only examples. There may be one, two, three, or more rows of electrical connectors 122 on a given electrical connection box and they may be connected to one, two, three, or more different rows of electrical connectors 120, in a wide variety of different configurations. The connectors shown in the present Figures are shown for the sake of example only.

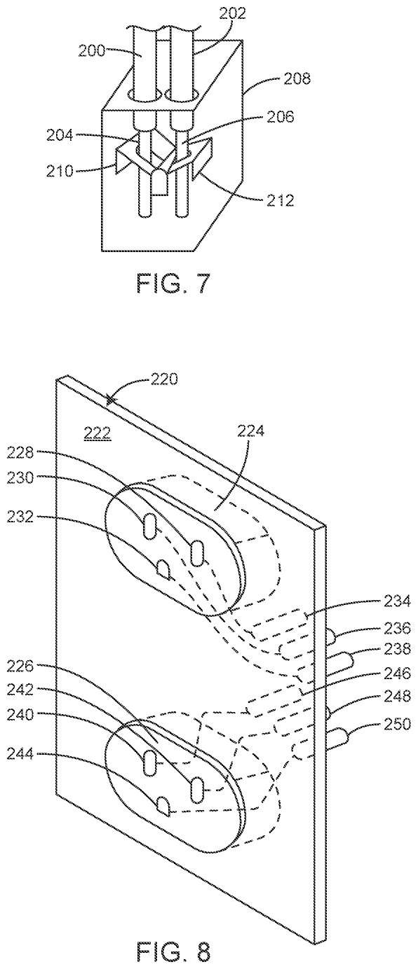

FIG. 7 shows one example of how electrical connections can be made between conductors and the push-in type receiving connectors. FIG. 7 shows two different conductors 200 and 202. Conductors 200 and 202 have been stripped of corresponding insulators to expose distal ends 204 and 206, respectively. A connection box 208 houses a set of push-in type receiving connectors 210 and 212. Connector 210 defines an opening for receiving the distal end 204 of conductor 200, for engaging and frictionally holding that conductor inside the opening. Similarly, connector 212 defines an opening for receiving the distal end 206 of conductor 202 and engaging and frictionally holding that conductor within the opening. These types of push-in receiving connectors are currently manufactured by and available from Wago Corporation of Germantown Wis. These are only examples and other types of push-in connectors can be used.

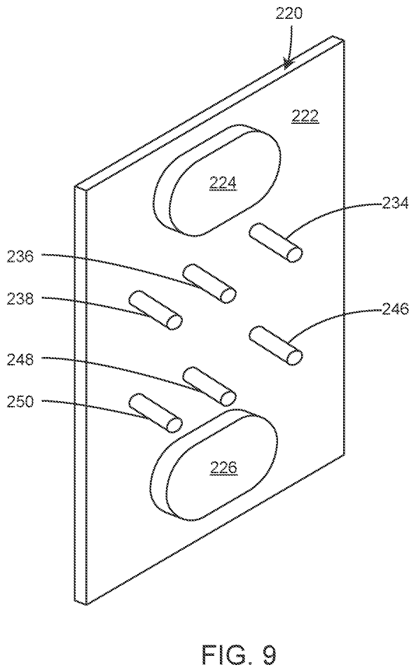

FIGS. 8 and 9 show two opposing perspective views of another faceplate assembly 220. Faceplate assembly 220 illustratively has a faceplate 222 with a pair of integrally formed (or otherwise fixedly attached) outlets 224 and 226. Outlet 224 has a set of electrical receiving apertures 228, 230 and 232 which are connected to a corresponding set of elongate members or studs 234, 236 and 238. Electrical outlet 226 has a set of electrical receiving apertures 240, 242 and 244 which are electrically connected to a corresponding set of elongate members or studs 246, 248 and 250, respectively.

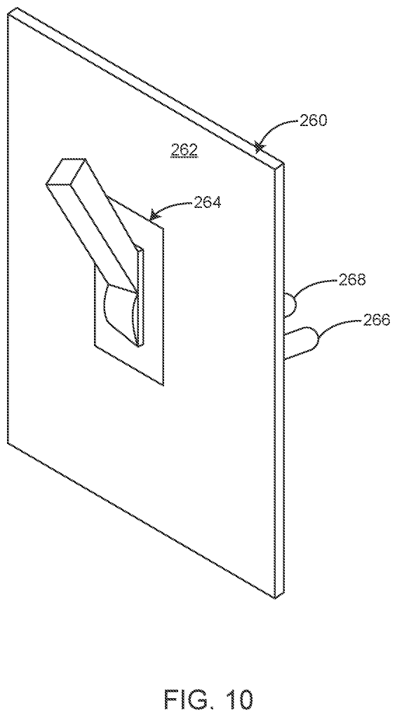

FIG. 10 is a perspective view of another example of a faceplate assembly 260. Assembly 260 illustratively includes a faceplate 262 and a switch 264. Switch 264 has electrical contacts that are formed at the opposite end of travel of the switch, and that are electrically connected to a set of elongate members or studs 266 and 268.

It will be appreciated that the electrical device that is integrally formed or otherwise fixedly attached to a faceplate can take a wide variety of different forms. As illustrated in the Figures, the electrical device can be an outlet or multiple outlets, or an electrical switch. The electrical device can also be a combination switch/outlet, a gang box, a ground fault outlet, a rheostat or a low voltage electrical device. Similarly, the receptacle (illustrated as receptacles 100, and 160 in the Figures) can also take different forms. The receptacle can also be a light base to which a light fixture is attached, a ceiling fan base or a base for another electrical device. The electrical device that plugs into the base illustratively includes the studs that plug into the push-in receiving connectors in the base.

The present receptacle thus improves safety by being configured so that no exposed wires, bus runs, or contacts are exposed inside the enclosure. This reduces the likelihood of possible injury from energized sources within the enclosure. Spring tension loaded or screw in place connections can be used, thus reducing the likelihood the wires will become dislodged, once connected. This also reduces the likelihood of poor connections, which may lead to the potential for overheating. Further, the wire configurations are illustratively identified on the enclosure or the junction box, along with identified input and output configurations. These indicators can be stamped into the box to provide installers with correctly aligned wire configurations. This reduces the likelihood of reverse polarization mistakes. Further, tabs can be provided with through holes that are tapered to accept sheetrock screws or nails, for fastening to framing studs. This allows for either left side or right side attachment to the framing stud. The tabs can be configured for either one ½ inch or ⅝^{th} inch sheetrock, with thickness stamped on to the enclosure to reduce the likelihood of an incorrect box being used with a given sheetrock thickness during installation. Similarly, the cover plate may have two molded-in screw hole insertion points which assist in holding the wiring or termination devices in place. The present system makes continuity checks easier and faster, and also saves time and materials by eliminating the need to insert and pull extra wires into each junction box. The modular design works with all wiring/termination devices, both high and low voltage devices. The modular design can be used with wire configurations of 2-5 wires (or different configurations) wherein the wires are solid or twisted wires. The receptable can be used in walls, floors, ceilings, etc., and can be designed for single and gang box deployments. The receptacle can be used in daisy chain implementation and either indoor or outdoor use.

It can thus be seen that the present discussion provides a receptacle to which a plurality of different electrical devices can be quickly and efficiently attached. In addition, power can be provided to, and received from, the receptacle by quickly and easily attaching power wires as well. The receiving chamber defined by the receptacle allows the operator (who may be installing an electrical device with a faceplate, switching an electrical device with a faceplate, etc.) to perform the operation without being exposed to bare electrical conductors. Also, by having a standardized connection structure (in terms of how the connectors in the connector box are electrically coupled to one another) standardized faceplates with integrally formed or fixedly connected electrical devices can be manufactured in a very efficient manner.

Example 1 is an electrical receptacle, comprising:

an enclosure including a floor, opposing side walls, an upper wall, and a back wall; and

a junction box fixedly attached to the back wall and having a first set of push-in receiving connectors within the enclosure and a second set of push-in receiving connectors electrically connected to the first set of push-in receiving connectors, the second set of push-in receiving connectors being exposed to an exterior of the enclosure.

Example 2 is the electrical receptacle of any or all previous examples wherein the junction box is configured with the second set of push-in receiving connectors being exposed to the exterior of the enclosure through the upper wall.

Example 3 is the electrical receptacle of any or all previous examples wherein the second set of receiving connectors are configured to define receiving openings that are coterminous with an exterior surface of the top wall.

Example 4 is the electrical receptacle of any or all previous examples and further comprising:

an electrical device having a set of male connectors configured to be received within the first set of push-in receiving connectors.

Example 5 is the electrical receptacle of any or all previous examples wherein the electrical device is configured with a first surface and a second surface, the set of male connectors extending away from the second surface of the electrical element for push-in engagement with the first set of push-in receiving connectors in the junction box within the enclosure.

Example 6 is the electrical receptacle of any or all previous examples wherein the first surface of the electrical device is configured to face outwardly relative to the enclosure in a direction opposite set of male connectors.

Example 7 is the electrical receptacle of any or all previous examples and further comprising:

a faceplate integrally formed with the electrical device and sized to close the enclosure upon insertion of the set of male connectors into the first set of push-in receiving connectors.

Example 8 is the electrical receptacle of any or all previous examples wherein the second set of push-in receiving connectors comprise wire-receiving connectors that frictionally engage and hold wires therein.

Example 9 is the electrical receptacle of any or all previous examples wherein the junction box is integrally formed with the back wall of the enclosure.

Example 10 is the electrical receptacle of any or all previous examples wherein the junction box is adhesively attached to the back wall of the enclosure.

Example 11 is the electrical receptacle of any or all previous examples wherein the electrical device comprises an outlet.

Example 12 is the electrical receptacle of any or all previous examples wherein the electrical device comprises a switch.

Example 13 is the electrical receptacle of any or all previous examples wherein the electrical device comprises a fixture base.

Example 14 is the electrical receptacle of any or all previous examples wherein the electrical device comprises a plurality of outlets.

Example 15 is the electrical receptacle of any or all previous examples wherein the electrical device comprises a gang box.

Example 16 is the electrical receptacle of any or all previous examples wherein the electrical device comprises a rheostat.

Example 17 is the electrical receptacle of any or all previous examples wherein the electrical device comprises a low voltage electrical device.

Example 18 is an electrical receptacle, comprising:

an enclosure including a floor, opposing side walls, an upper wall, and a back wall;

a junction box fixedly attached to the back wall and having a first set of push-in receiving connectors within the enclosure and a second set of push-in receiving connectors electrically connected to the first set of push-in receiving connectors, the second set of push-in receiving connectors being exposed to an exterior of the enclosure through the upper wall; and

an electrical device having a set of male connectors configured to be received within the first set of push-in receiving connectors.

Example 19 is the electrical receptacle of any or all previous examples and further comprising:

a faceplate integrally formed with the electrical device and sized to close the enclosure upon insertion of the set of male connectors into the first set of push-in receiving connectors.

Example 20 is an electrical receptacle, comprising:

an enclosure including a floor, opposing side walls, an upper wall, and a back wall;

a junction box fixedly attached to the back wall and having a first set of push-in receiving connectors within the enclosure and a second set of push-in receiving connectors electrically connected to the first set of push-in receiving connectors, the second set of push-in receiving connectors being exposed to an exterior of the enclosure;

an electrical device having a set of male connectors configured to be received within the first set of push-in receiving connectors; and

a faceplate integrally formed with the electrical device and sized to close the enclosure upon insertion of the set of male connectors into the first set of push-in receiving connectors.

Although the present invention has been described with reference to examples, workers skilled in the art will recognize that changes may be made in form and detail without departing from the spirit and scope of the invention

What is claimed is:

1. An electrical receptacle, comprising:
an enclosure including a floor, opposing side walls, an upper wall, and a back wall; and
a junction box fixedly attached to the back wall and having a first set of push-in receiving connectors within the enclosure and a second set of push-in receiving connectors electrically connected to the first set of push-in receiving connectors, the second set of push-in receiving connectors being exposed to an exterior of the enclosure.

2. The electrical receptacle of claim 1 wherein the junction box is configured with the second set of push-in receiving connectors being exposed to the exterior of the enclosure through the upper wall.

3. The electrical receptacle of claim 2 wherein the second set of receiving connectors are configured to define receiving openings that are coterminous with an exterior surface of the top wall.

4. The electrical receptacle of claim 1 and further comprising:
an electrical device having a set of male connectors configured to be received within the first set of push-in receiving connectors.

5. The electrical receptacle of claim 4 wherein the electrical device is configured with a first surface and a second surface, the set of male connectors extending away from the second surface of the electrical element for push-in engagement with the first set of push-in receiving connectors in the junction box within the enclosure.

6. The electrical receptacle of claim 5 wherein the first surface of the electrical device is configured to face outwardly relative to the enclosure in a direction opposite set of male connectors.

7. The electrical receptacle of claim 6 and further comprising:
a faceplate integrally formed with the electrical device and sized to close the enclosure upon insertion of the set of male connectors into the first set of push-in receiving connectors.

8. The electrical receptacle of claim 7 wherein the second set of push-in receiving connectors comprise wire-receiving connectors that frictionally engage and hold wires therein.

9. The electrical receptacle of claim 1 wherein the junction box is integrally formed with the back wall of the enclosure.

10. The electrical receptacle of claim 1 wherein the junction box is adhesively attached to the back wall of the enclosure.

11. The electrical receptacle of claim 4 wherein the electrical device comprises an outlet.

12. The electrical receptacle of claim 4 wherein the electrical device comprises a switch.

13. The electrical receptacle of claim 4 wherein the electrical device comprises a fixture base.

14. The electrical receptacle of claim 4 wherein the electrical device comprises a plurality of outlets.

15. The electrical receptacle of claim 4 wherein the electrical device comprises a gang box.

16. The electrical receptacle of claim 4 wherein the electrical device comprises a rheostat.

17. The electrical receptacle of claim 4 wherein the electrical device comprises a low voltage electrical device.

18. An electrical receptacle, comprising:
an enclosure including a floor, opposing side walls, an upper wall, and a back wall;
a junction box fixedly attached to the back wall and having a first set of push-in receiving connectors within the enclosure and a second set of push-in receiving connectors electrically connected to the first set of push-in receiving connectors, the second set of push-in receiving connectors being exposed to an exterior of the enclosure through the upper wall; and
an electrical device having a set of male connectors configured to be received within the first set of push-in receiving connectors.

19. The electrical receptacle of claim 18 and further comprising:
a faceplate integrally formed with the electrical device and sized to close the enclosure upon insertion of the set of male connectors into the first set of push-in receiving connectors.

20. An electrical receptacle, comprising:
an enclosure including a floor, opposing side walls, an upper wall, and a back wall;
a junction box fixedly attached to the back wall and having a first set of push-in receiving connectors within the enclosure and a second set of push-in receiving connectors electrically connected to the first set of push-in receiving connectors, the second set of push-in receiving connectors being exposed to an exterior of the enclosure;
an electrical device having a set of male connectors configured to be received within the first set of push-in receiving connectors; and
a faceplate integrally formed with the electrical device and sized to close the enclosure upon insertion of the set of male connectors into the first set of push-in receiving connectors.
